(19) United States
(12) Patent Application Publication
(10) Pub. No.: US 2025/0237798 A1
(43) Pub. Date: Jul. 24, 2025

(54) Optical Element, Optical Cell, Analysis Device, and Optical Element Design Method

(71) Applicant: National Institute of Information and Communications Technology, Tokyo (JP)

(72) Inventors: Kentaro Iwami, Fuchu-shi (JP); Motoaki Hara, Koganei-shi (JP); Yuichiro Yano, Koganei-shi (JP); Tetsuya Ido, Koganei-shi (JP)

(21) Appl. No.: 18/853,329

(22) PCT Filed: Mar. 23, 2023
(86) PCT No.: PCT/JP2023/011373

§ 371 Date: Oct. 1, 2024

(30) Foreign Application Priority Data
Apr. 5, 2022 (JP) 2022-062908

(51) Int. Cl. G02B 5/30; G02B 27/00

(52) U.S. Cl. CPC G02B 5/3083; G02B 27/0012

(57) ABSTRACT

An optical element includes a plurality of pillar-shaped bodies that are formed of a material with a predetermined dielectric constant on a flat surface of a transparent substrate through which light is transmitted and that are arranged in a matrix shape. Each pillar-shaped body is formed to perform phase adjustment on output light which is output by transmission of input light, on the basis of the dielectric constant, a sectional shape in a direction parallel to the flat surface, and a length in a normal direction with respect to the flat surface, to adjust deflection characteristics with respect to the normal direction, lens characteristics of condensing light with respect to the normal direction, and polarized wave characteristics with respect to the normal direction, and to output the output light having a desired polarized light characteristics.

### TECHNICAL FIELD

The present invention relates to an optical element, an optical cell, an analysis device, and an optical element design method for utilizing optical characteristics of materials. Priority is claimed on Japanese Patent Application No. 2022-062908, filed Apr. 5, 2022, the content of which is incorporated herein by reference.

### BACKGROUND ART

In a case where components of a minute amount of sample (sample) with high fluidity such as a gas or a liquid are analyzed, spectroscopic analysis based on optical characteristics of the sample is used. For example, in general spectroscopic analysis, characteristics of a sample is analyzed by outputting light such as a laser beam from a large light source, condensing the light using a lens system of a microscope or the like, irradiating the sample placed in a minute area with the light, performing spectrometry on light emitted from the excited sample, and analyzing spectra thereof (for example, see Non-Patent Document 1).

In a case where optical characteristics of a sample are known, an optical cell housing the sample may be used as an optical device using the characteristics of excited light which is output by inputting light to the sample. For example, Patent Document 1 states that light is input to an optical cell housing cesium vapor as a sample and an oscillator of an atomic clock is constructed using optical characteristics such as the frequency of excited light output from the optical cell.

The optical cell described in Patent Document 1 includes a housing unit in which a flow channel for housing a sample is formed and a transparent substrate that covers the housing unit. The optical cell includes a light source that inputs light such as a laser beam to the housing unit and a detector that detects light transmitted by a sample. The housing unit of the optical cell is formed of a silicone substrate. In the silicone substrate, a flow channel is formed by wet etching in a cross-section. A first tilted surface and a second tilted surface are formed to face each other on both sides of the flow channel. The magnitude of an angle formed by the first tilted surface and the second tilted surface is about 55 degrees. The optical cell forms an optical path in a longitudinal direction of the flow channel by allowing the first tilted surface and the second tilted surface to reflect light input from the transparent substrate side and outputting output light to the transparent substrate side.

In the optical cell described in Patent Document 1, a diffraction grating is provided in the transparent substrate to cause light input to the transparent substrate to be reflected by the first tilted surface and to output light reflected by the second tilted surface from the transparent substrate. In the optical cell described in Patent Document 1, incident light is diffracted and split using the diffraction grating provided in the transparent substrate and only light diffracted at an appropriate angle is input to the flow channel using a partition plate formed of a metal film, whereby an optical path is formed.

### CITATION LIST

### Patent Document

Patent Document 1: U.S. Pat. No. 9,488,962

### Non-Patent Document

Non-Patent Document 1: R. G. Messerschmidt, and M. Harthcock, “Infrared Microspectroscopy,” Mercel Dekkar, New York (1988)
Non-Patent Document 2: S. Sun et al., “High-efficiency broadband anomalous reflection by gradient meta-surfaces,” Nano Lett., vol. 12, no. 12, pp. 6223-9, December 2012
Non-Patent Document 3: Z. Zhou et al., “Efficient Silicon Metasurfaces for Visible Light,” ACS Photonics, vol. 4, no. 3, pp. 544-551, 2017

### SUMMARY OF INVENTION

### Technical Problem

In the optical cell described in Patent Document 1, since light input from the light source is split into two directions by the diffraction grating, there is a problem in that the light intensity is attenuated by 50% or more.

An objective of the present invention is to provide an optical element, an optical cell, an analysis device, and an optical element design method that can enhance transmission efficiency of light and provide a desired deflection direction, a desired light condensing, and a desired polarized state.

### Solution to Problem

According to an aspect of the present invention, there is provided an optical element including a plurality of pillar-shaped bodies that are formed of a material with a predetermined dielectric constant on a flat surface of a transparent substrate through which light is transmitted and that are arranged in a matrix shape, wherein each pillar-shaped body is formed to perform phase adjustment on output light which is output by transmission of input light on the basis of the dielectric constant, a sectional shape in a direction along the flat surface, and a length in a normal direction with respect to the flat surface, to adjust deflection characteristics with respect to the normal direction, lens characteristics with respect to the normal direction, and polarized wave characteristics in the normal direction, and to output the output light in a desired polarized state.

### Advantageous Effects of Invention

According to the present invention, it is possible to design an optical element that can enhance detection efficiency of light and provide a desired deflection direction, a desired light condensing, and a desired polarized state.

### BRIEF DESCRIPTION OF DRAWINGS

FIG. 1 a sectional view illustrating a configuration of an optical cell according to an embodiment.

FIG. 2 a block diagram illustrating a configuration of a detection device using the optical cell.

FIG. 3 a perspective view illustrating a configuration of an optical element.

FIG. 4 a diagram illustrating a phase distribution based on a first function.

FIG. 5 a diagram illustrating a relationship between the width and the transmittance of a pillar-shaped body and the amount of phase delay.

FIG. 6 a diagram illustrating a relationship between the width of a pillar-shaped body and the amount of phase delay.

FIG. 7 a perspective view illustrating an arrangement state of a plurality of pillar-shaped bodies.

FIG. 8 a diagram illustrating a calculation result obtained by analyzing an electric field of the plurality of pillar-shaped bodies.

FIG. 9 a diagram illustrating a diffraction angle based on the plurality of pillar-shaped bodies.

FIG. 10 a diagram illustrating a phase distribution based on a second function.

FIG. 11 a diagram illustrating a phase distribution based on a phase distribution function.

FIG. 12 a diagram illustrating a calculation result obtained by analyzing an electric field of an optical element formed on a ¼ wavelength plate.

FIG. 13 a diagram illustrating a calculation result obtained by analyzing an electric field of a plurality of pillar-shaped bodies formed on a ¼ wavelength plate.

FIG. 14 a flowchart illustrating a process flow that is performed in an optical element design method.

FIG. 15 a sectional view illustrating a configuration of an optical cell according to a modified example.

FIG. 16 a diagram illustrating the transmittance in a case where the length and the width of a pillar-shaped body are adjusted.

FIG. 17 a diagram illustrating an amount of phase delay in a case where the length and the width of a pillar-shaped body are adjusted.

### DESCRIPTION OF EMBODIMENTS

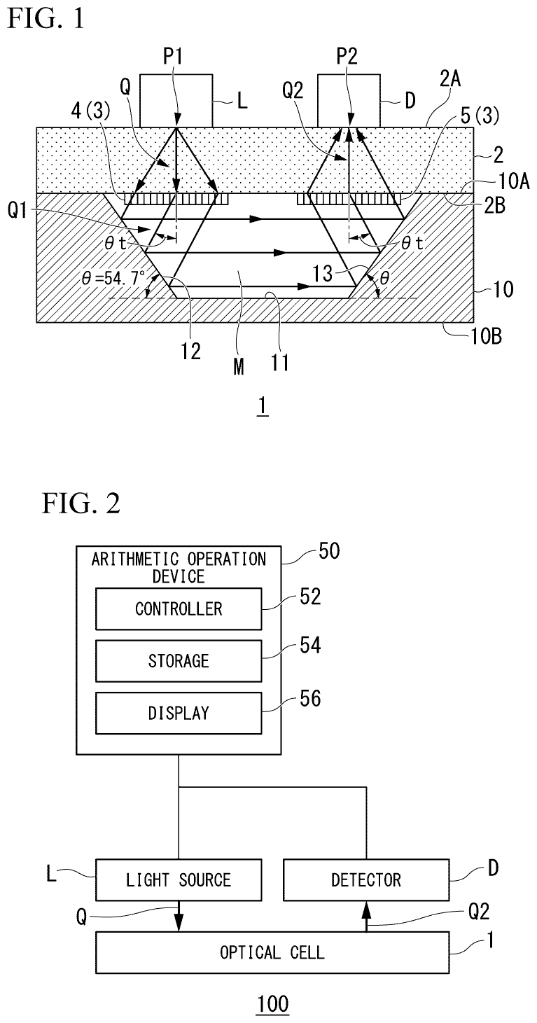

As illustrated in FIG. 1, an optical cell 1 includes a substrate 2 that is formed of a material transmitting light, a first optical element layer 4 that is formed of an optical element 3 disposed at a first position P1 on the substrate 2, a second optical element layer 5 that is formed of an optical element 3 disposed at a second position P2 of the substrate 2, and a housing layer 10 which is stacked on the substrate 2 and in which a flow channel 11 for housing a sample M to be examined or a material as an oscillation source is formed. Here, the first position P1 and the second position P2 are coincident in a thickness direction of the substrate 2.

The substrate 2 is formed, for example, as a rectangular plate-shaped body made of a transparent glass material. A first surface 2A of the substrate 2 is exposed to the outside. The first surface 2A and a second surface 2B of the substrate 2 may be coated to form an antireflection film for preventing reflection of light. A light source L that outputs light Q is disposed at the first position P1 on the first surface 2A side of the substrate 2. The light source L inputs light Q to the first position PT. The first surface 2A of the substrate 2 and the light source L may be in contact with each other or separated from each other. The light source L is constituted, for example, by an element outputting light such as a semiconductor laser element outputting a laser beam or a light emitting diode (LED) element. A detector D that detects output light output from a second position P2 different from the first position P1 on the first surface 2A of the substrate 2 is disposed at the second position P2. The detector D is constituted, for example, by an element detecting light such as a photodiode. The first surface 2A of the substrate 2 and the detector D may be in contact with each other or separated from each other.

The first optical element layer 4 constituted by an optical element 3 having predetermined optical characteristics is provided at the first position P1 on the second surface 2B of the substrate 2. The optical element 3 has a metasurface structure which is formed to output light with a desired polarized state. The configuration of the optical element 3 will be described later. The first optical element layer 4 receives an input of light which has been input from the light source L at the first position P1 and passed through the substrate 2, and is configured to adjust the phase of output light which is output by transmission of input light. The first optical element layer 4 receives an input of light which has been input from the light source L at the first position P1 and passed through the substrate 2, and is formed to adjust deflection characteristics, with respect to the normal direction, of the output light which is output by transmission of input light.

The first optical element layer 4 receives an input of light which has been input from the light source L at the first position P1 and passed through the substrate 2, and is formed to adjust lens characteristics of collimating, with respect to the normal direction, the output light which is output by transmission of input light. The first optical element layer 4 receives an input of light which has been input from the light source L at the first position P1 and passed through the substrate 2, and is formed to adjust polarized wave characteristics, with respect to the normal direction, of the output light which is output by transmission of input light. The first optical element layer 4 may be formed to adjust polarized wave characteristics such that light is condensed on a focal point.

The second optical element layer 5 constituted by an optical element 3 having predetermined optical characteristics is provided at the second position P2 on the second surface 2B of the substrate 2. The second optical element layer 5 receives an input of light which has passed through a sample M at the second position P2, and is formed to adjust the phase of output light which is output to the substrate 2 by transmission of input light. The second optical element layer 5 receives an input of light which has passed through a sample M at the second position P2, and is formed to adjust deflection characteristics, with respect to the normal direction, of output light which is output to the substrate 2 by transmission of input light.

The second optical element layer 5 receives an input of light which has passed through a sample M at the second position P2, and is formed to adjust lens characteristics of adjusting light condensing, with respect to the normal direction, of output light which is output to the substrate 2 by transmission of input light. The second optical element layer 5 receives an input of light which has passed through a sample M at the second position P2, and is formed to adjust polarized wave characteristics, with respect to the normal direction, of output light which is output to the substrate 2 by transmission of input light.

The housing layer 10 is provided on the second surface 2B side of the substrate 2. The housing layer 10 is formed, for example, of a single-crystal material of silicon. A first surface 10A of the housing layer 10 is in contact with the second surface of the substrate 2. A groove-shaped flow channel 11 which is recessed from the first surface 10A side is formed on the first surface 10A of the housing layer 10 in a sectional view. The flow channel 11 is formed, for example, by etching the first surface 10A of the housing layer 10. The flow channel 11 is formed in a housing space for housing a sample to be examined or a material to be an oscillation source by being covered with the substrate 2. For example, the flow channel 11 hermetically houses a material. The flow channel 11 may not be completely closed, but may be configured to house a material which is a fluid to be flow.

A plurality of reflecting plates are formed on both sides in the flow channel 11 such that first output light Q1 output from the first optical element layer 4 provided at the first position is reflected and output to the second position P2 of the substrate 2 in a sectional view. The plurality of reflecting plates include, for example, a first reflecting plate 12 provided to correspond to the first position P1 and a second reflecting plate 13 provided to correspond to the second position P2.

The first reflecting plate 12 is formed at a tilt angle θ at which the width of the flow channel 11 increases from the bottom of the flow channel 11 to an opening on the first surface 10A side of the housing layer 10 in a sectional view. The first reflecting plate 12 is constituted by a crystal plane of the substrate 2. The tilt angle θ is, for example, 54.7 degrees. The first reflecting plate 12 reflects first output light Q1 output from the first optical element layer 4 in a direction along a width direction (an X-axis direction in the drawing) of the flow channel 11. The first reflecting plate 12 reflects the first output light Q1 in the width direction in which an optical path length is longer than in a depth direction (a Z-axis direction in the drawing) of the flow channel 11. The second reflecting plate 13 is disposed to face the first reflecting plate 12 in the width direction of the flow channel 11.

The second reflecting plate 13 is formed to be symmetric to the first reflecting plate 12 in the width direction of the flow channel 11. The second reflecting plate 13 is formed at a tilt angle θ at which the width of the flow channel 11 increases from the bottom of the flow channel 11 to an opening on the first surface 10A side of the housing layer 10 in a sectional view. The second reflecting plate 13 is constituted by a crystal plane of the substrate 2. The tilt angle θ is, for example, 54.7 degrees. For example, the second reflecting plate 13 reflects the first output light Q1 reflected by the first reflecting plate 12 and inputs the reflected light to the second optical element layer 5. The second optical element layer 5 receives an input of the first output light Q1, provides a predetermined polarized state to the first output light Q1, and outputs second output light Q2 (also simply referred to as output light). The second output light Q2 is transmitted by the substrate 2 and input to the detector D.

FIG. 2 illustrates a configuration of an analysis device 100 using the optical cell 1. The analysis device 100 is, for example, a device that analyzes characteristics of a sample M on the basis of optical characteristics of the sample M housed in the optical cell 1. The analysis device 100 includes, for example, an optical cell 1 that houses a sample M, a light source L that inputs light Q to the first position P1 of the optical cell 1, a detector D that detects second output light Q2 output from the second position P2 of the optical cell 1, and an arithmetic operation device 50 that controls the light source L, acquires a detection result from the detector D, and determines characteristics of the sample M on the basis of an arithmetic operation using the detection result. The detector D is configured to detect a desired optical physical quantity of the sample M. By changing the configuration of the detector D, the analysis device 100 may be used as a spectroscopic instrument, a resonance line acquisition device, a spectrophotometer, or the like.

The arithmetic operation device 50 is constituted, for example, by an information processing terminal device such as a personal computer. The arithmetic operation device 50 may be a server device connected to the light source L or the detector D via a network. The arithmetic operation device 50 includes, for example, a controller 52 that controls the light source L and outputs a predetermined arithmetic operation result, a storage 54 that stores data on an arithmetic operation, and a display 56 that displays information based on the arithmetic operation result. The storage 54 is constituted, for example, by a non-transitory storage medium such as an SSD or a flash memory. The display 56 is constituted by a display device such as a liquid crystal display or an organic electroluminescence (EL) display. The display 56 displays a display image which is generated by the controller 52.

The controller 52 acquires detection data acquired by the detector D, performs predetermined arithmetic operations using the detection result, and outputs an arithmetic operation result associated with predetermined physical characteristics of a sample M. The controller 52 generates a display image indicating the arithmetic operation result and displays the generated display image on the display 56. The controller 52 is realized, for example, by causing a hardware processor such as a central processing unit (CPU) to execute a program (software). Some or all of these constituents may be realized by hardware (a circuit unit including circuitry) such as a large-scale integration (LSI) device, an application-specific integrated circuit (ASIC), a field-programmable gate array (FPGA), or a graphics processing unit (GPU) or may be cooperatively realized by software and hardware. The program may be stored in a storage device such as a hard disk drive (HDD) or a flash memory of the storage 54 in advance or may be stored in a detachable storage medium such as a DVD or a CD-ROM and installed in the storage device by setting the storage medium into a drive device.

The configuration and principle of the optical element 3 will be described below. The optical element 3 is configured to give a gradient to a phase when light propagates in an interface between two types of different materials with different propagation speeds of light and to arbitrarily control a deflection angle or polarized light characteristics of light which is caused from a difference in propagation speed. The optical element 3 has, for example, a metasurface structure in which a periodic structure of a metal or a dielectric material is formed in the interface between two types of different materials with different propagation speeds of light and a period thereof is less than a product of a wavelength and a refractive index. The metasurface structure may be formed of a material having light transmission in a wavelength band of a used laser in addition to a metal or a dielectric material. Here, an element that refracts and deflects light on the basis of a metasurface structure is referred to as a metasurface deflector (for example, see Non-Patent Document 2 and Non-Patent Document 3).

As illustrated in FIG. 1, the light source L inputs light Q in the normal direction (the Z-axis direction in the drawing) perpendicular to the surface of the substrate 2 at the first position P1. The light Q propagates in the substrate 2, is input to the optical element 3 (the first optical element layer 4) on the second surface 10B of the substrate 2, and is output as first output light Q1 into the flow channel 11 filled with a sample M. The optical element 3 (the first optical element layer 4) disposed at the first position P1 has a function of refracting light Q input in an in-plane direction of the substrate 2 from the light source L by a predetermined deflection angle θt=19.48° with respect to the normal direction (the Z-axis direction) at a position on the second surface 2B of the substrate 2 which is an interface between the substrate 2 and the sample M on the basis of the metasurface structure and outputting the refracted light as first output light Q1. The optical element 3 disposed at the first position P1 has a function of collimating light Q input and diffusing in the in-plane direction of the substrate 2 from the light source L and outputting the collimated light as parallel light on the basis of the metasurface structure.

Similarly, the optical element 3 (the second optical element layer 5) disposed at the second position P2 has a function of refracting light input at a predetermined deflection angle θt=19.48° with respect to the normal direction through the second reflecting plate 13 in a direction perpendicular to the in-plane direction of the substrate 2 on the basis of the metasurface structure and outputting the refracted light as second output light Q2. The optical element 3 disposed at the second position P2 has a function of receiving parallel light and outputting light to be focused on a focal point at a predetermined position on the basis of the metasurface structure.

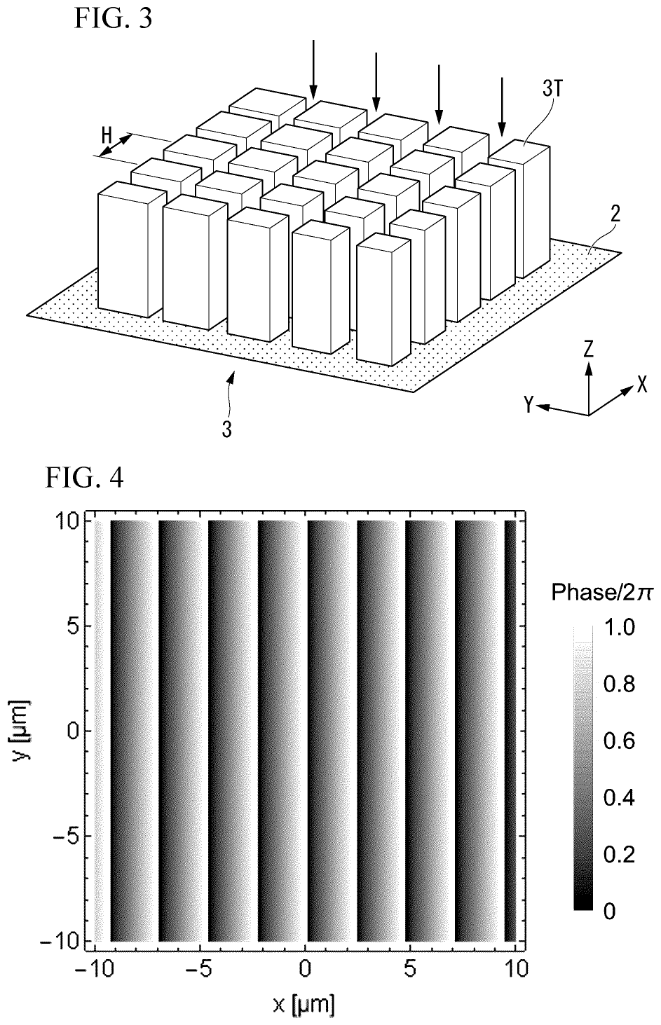

As illustrated in FIG. 3, the optical element 3 is formed in a metasurface structure including a plurality of minute pillar-shaped bodies 3T arranged in a matrix shape. FIG. 3 illustrates a unit element of the metasurface structure. A distance H between neighboring pillar-shaped bodies 3T is, for example, several hundreds of nm. The optical element 3 is formed of a material with a predetermined dielectric constant on the flat surface of the transparent substrate 2 through which light is transmitted using an etching process or the like. The pillar-shaped bodies 3T are preferably formed of a material with a high refractive index. The material of the pillar-shaped bodies 3T is, for example, single-crystal silicon. Ge, amorphous silicon, GaN, TiO₂, SiN, or ZrO₂, or the like may be used as the material of the pillar-shaped bodies 3T. The material of the pillar-shaped bodies 3T is not particularly limited as long as it has the same optical characteristics.

Each pillar-shaped body 3T serves as a waveguide for guiding light. Each pillar-shaped body 3T is formed to perform phase adjustment (also referred to as phase delay) on output light which is output by transmission of input light by adjusting parameters such as a dielectric constant, a sectional shape in a direction along the flat surface, and a length in the normal direction with respect to the flat surface. By arranging pillar-shaped bodies 3T having different amounts of phase adjustment in a matrix shape on the basis of a predetermined arrangement method, the optical element 3 that outputs output light having a desired polarized light characteristics is formed. For example, a method of designing the optical element 3 for deflecting input light by a predetermined deflection angle θt will be described below. The pillar-shaped bodies 3T according to the embodiment are set to a predetermined value in the length direction. According to Non-Patent Document 5, an incidence angle θi of light, a deflection angle θt, an incidence-side refractive index ni, an exit-side refractive index nt, a phase gradient dϕ/dx, and a wavelength λ satisfy a relationship represented by Expression (1).

$$\begin{matrix}[ Math . 1 ] & \\ {n}_{t} sin {θ}_{t} - {n}_{i} sin {θ}_{i} = \frac{λ}{2 π} \frac{d ϕ}{d x} & ( 1 )\end{matrix}$$

In Expression (1), in a case where it is assumed that light is input vertically and a medium on an output side is gas, θi=0 and nt=1 are established. In the optical element 3 according to this embodiment, a predetermined deflection angle θt in the optical element 3 needs to be given to light output from the substrate 2 such that light incident on the substrate 2 in the vertical direction is incident on the first reflecting plate 12 at a predetermined incidence angle (see FIG. 1). The optical element 3 is formed to give a phase gradient and a predetermined deflection angle θt to output light, for example, when input light is output. Expression (2) is a first function indicating a distribution of phase gradient to which the metasurface structure of the optical element 3 gives to light.

$$\begin{matrix}[ Math . 2 ] & \\ {ϕ}_{D} ( x ) = \frac{d ϕ}{d x} x & ( 2 )\end{matrix}$$

A plurality of pillar-shaped bodies are designed on the basis of the first function ϕ_{D}(x) indicating a phase distribution of output light in a plan view using Expression (2). Here, since the predetermined deflection angle θt in this embodiment is 19.48°, the first function ϕ_{D}(x) is expressed by Expression (3) on the basis of Expression (1) and Expression (2).

$$\begin{matrix}[ Math . 3 ] & \\ {ϕ}_{D} ( x ) = \frac{2 π}{λ / sin 19.48 °} x & ( 3 )\end{matrix}$$

As illustrated in FIG. 4, the first function ϕ_{D}(x) indicates a phase distribution in a two-dimensional plane in which input light is refracted by the predetermined deflection angle θt. In FIG. 4, a remainder which is obtained by dividing the first function ϕ_{D}(x) by 2π is illustrated in consideration of periodicity of a phase. The plurality of pillar-shaped bodies 3T based on the first function are formed in a sectional shape in which a first width in a first direction along the flat surface and a second width in a second direction (a Y-axis direction) perpendicular to the first direction (an X-axis direction) along the flat surface are adjusted. The first width and the second width are set to satisfy the sectional shape providing a phase closest to the remainder of the first function with respect to 2π. By adjusting the first width and the second width and adjusting a sectional area, an amount of phase delay of light passing through the pillar-shaped bodies 3T changes. The plurality of pillar-shaped bodies 3T are sequentially arranged in the first direction and the second direction in the order of sectional areas of the sectional shapes, and deflection characteristics thereof are adjusted such that a phase gradient with which output light has a desired deflection angle with respect to the normal direction is given. The structure of the optical element 3 having such a phase gradient can be calculated on the basis of electromagnetic field analysis.

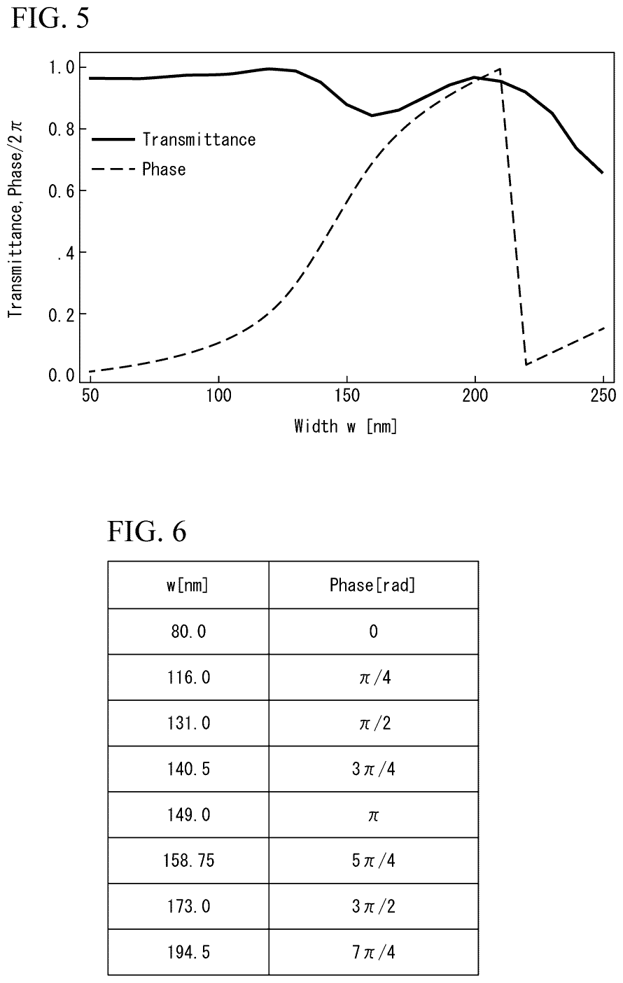

FIG. 5 illustrates optical characteristics of the pillar-shaped bodies 3T which are formed of a material of single-crystal silicon. Each pillar-shaped body 3T has, for example, a square section, and a height thereof is set to 400 nm. In calculation, a rate of change in transmittance and phase in a case where the width w of one side of the square sectional shape changes is calculated. As the calculation result, it can be seen that the pillar-shaped body 3T has high transmittance of 80% or more and a phase change of 0 to 2π is obtained. FIG. 6 illustrates calculation results of a relationship between the phase change of 0 to 2π and the width of one side in steps of 1/4π.

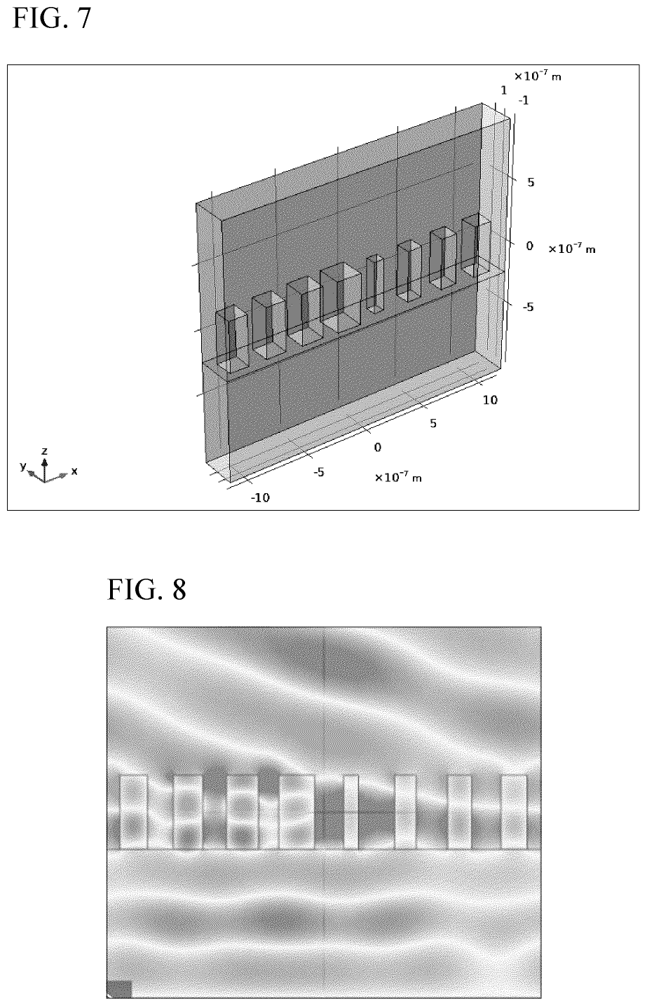

As illustrated in FIG. 7, 8 types of pillar-shaped bodies 3T having different sectional shapes are arranged on the basis of the calculation results, and electromagnetic field analysis for simulating a change in electromagnetic field generated near the pillar-shaped bodies 3T is performed. 8 types of pillar-shaped bodies 3T are arranged according to the magnitude of the sectional areas.

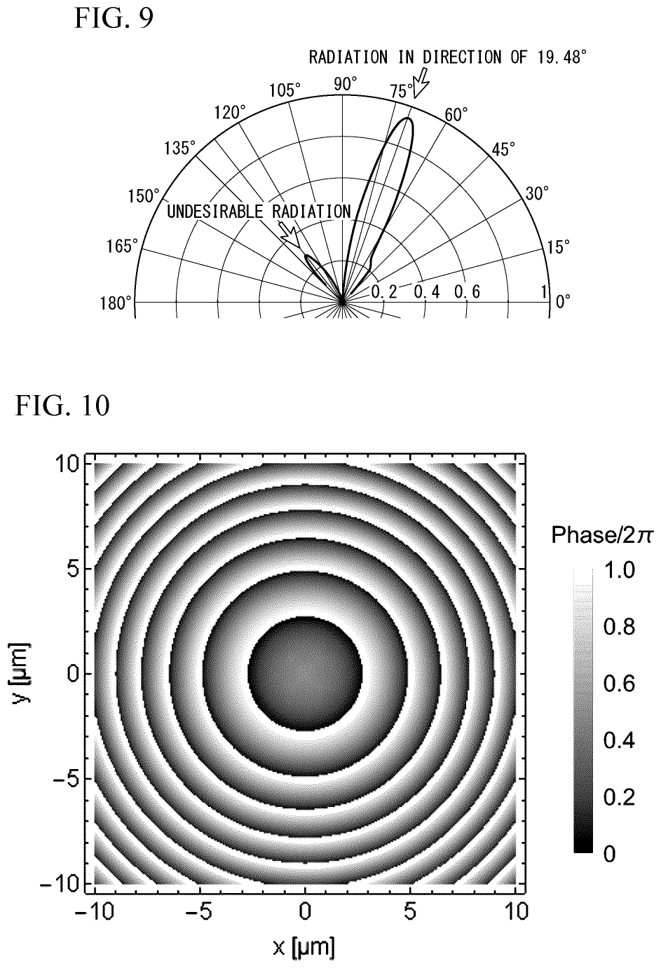

FIG. 8 illustrates a state in which input light is incident on the pillar-shaped bodies 3T from below and output light exits from above. Periodic boundary conditions are set near the pillar-shaped bodies 3T. As illustrated in FIG. 9, the plurality of pillar-shaped bodies 3T are designed to obtain strong radiation in a direction of the predetermined deflection angle θ=19.48°. The optical element 3 is formed in a metasurface structure in which unit elements including the plurality of pillar-shaped bodies 3T are arranged in a matrix shape and serves as a light deflection element in which output light has a desired deflection angle with respect to the normal direction.

The optical element 3 may be designed to have different polarized light characteristics in addition to the light deflection element. For example, in the optical cell 1, since light output from the light source L generally has a divergence angle, and thus the output light needs to be made to be parallel light using a collimate lens (see FIG. 1). The optical element 3 may be formed as a lens element having a function of a convex lens that outputs diverging input light as parallel light. Expression (4) is a second function indicating a phase distribution of the collimate lens.

$$\begin{matrix}[ Math . 4 ] & \\ {ϕ}_{L} ( x , y ) = - \frac{2 π}{λ} ( \sqrt{{x}^{2} + {y}^{2} + {f}^{2}} - f ) & ( 4 )\end{matrix}$$

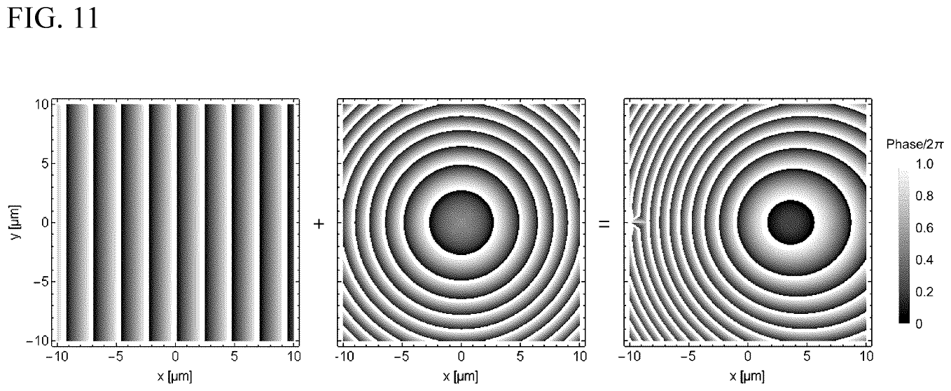

FIG. 10 illustrates a remainder of a phase distribution based on the second function with respect to 2π. In the optical element 3, the plurality of pillar-shaped bodies 3T are designed on the basis of the second function indicating a phase distribution of output light on the flat surface. The first width and the second width of a sectional area of each pillar-shaped body 3T are adjusted to obtain a phase gradient at coordinates corresponding to the second function. Here, the first width and the second width are set to satisfy a sectional shape giving a phase closest to the remainder of the second function with respect to 2π. The optical element 3 designed as described above serves as a lens element in which the phase is adjusted and the lens characteristics are adjusted such that output light has a focal point at a desired focal distance with respect to the normal direction by arranging unit elements including a plurality of pillar-shaped bodies 3T having the phase distribution based on the second function in a matrix shape. With the optical element 3 formed as a lens element, in a case where the optical element 3 is provided as the first optical element layer 4 at the first position P1, light output at a divergence angle from the light source L can be output as parallel light (see FIG. 1). With the optical element 3 formed as a lens element, in a case where the optical element 3 is provided as the second optical element layer 5 at the second position P2, parallel light reflected by the second reflecting plate 13 can be received and output light can be condensed and input to the detector D (see FIG. 1).

The optical elements 3 having different polarized light characteristics may be stacked to combine the functions thereof. The optical element 3 may be designed on the basis of a combined function in which the first function and the second function set to have different polarized light characteristics are combined. For example, the optical element 3 may be formed on the basis of a phase distribution function expressed by Expression (5) in which the first function and the second function are combined.

$$\begin{matrix}[ Math . 5 ] & \\ ϕ ( x , y ) = {ϕ}_{D} ( x ) + {ϕ}_{L} ( x , y ) & ( 5 )\end{matrix}$$

FIG. 11 illustrates a remainder with respect to 2π of the phase distribution function in which the first function and the second function are combined. Here, the first width and the second width of each of a plurality of pillar-shaped bodies 3T are set to satisfy a sectional shape giving a phase closest to the remainder with respect to 2π of the phase distribution function in which the first function and the second function are combined. With the optical element 3 designed on the basis of the phase distribution function, it is possible to design a metasurface structure in which functions causing different polarized light characteristics are superimposed and to realize both the function of a deflection element or a deflector and the function of a metasurface using a single layer.

According to use of the optical cell 1, it may be preferable in view of optical characteristics of a sample M that light output from the light source L be converted from linearly polarized light to circularly polarized light (see FIG. 1). The optical element 3 may be constituted, for example, by a ¼ wavelength plate which is a phase difference plate. Expression (6) is a third function indicating a phase distribution of the ¼ wavelength plate.

$$\begin{matrix}[ Math . 6 ] & \\ {ϕ}_{y} = {ϕ}_{x} + \frac{π}{2} & ( 6 )\end{matrix}$$

In the optical element 3, the plurality of pillar-shaped bodies 3T are designed on the basis of the third function indicating a phase distribution of output light on the flat surface. The first width and the second width of the sectional area are adjusted such that each pillar-shaped body 3T satisfies a phase gradient at coordinates corresponding to the third function. Here, the first width and the second width of each of the plurality of pillar-shaped bodies 3T are set to satisfy a sectional shape giving a phase closest to the remainder with respect to 2π of the third function. The pillar-shaped bodies 3T are adjusted such that a phase difference of π/2 is caused between a first phase in the first direction of the output light and a second phase in the second direction perpendicular to the first direction and output light becomes circularly polarized light in the normal direction.

The optical element 3 constituted by a ¼ wavelength plate can construct a metasurface having polarization dependency of a phase, that is, double refraction, by changing the sectional shape of each pillar-shaped body 3T from square to rectangle. By selecting a pillar satisfying Expression (6) of a phase relationship like a ¼ wavelength plate, it is possible to realize the function of the ¼ wavelength plate.

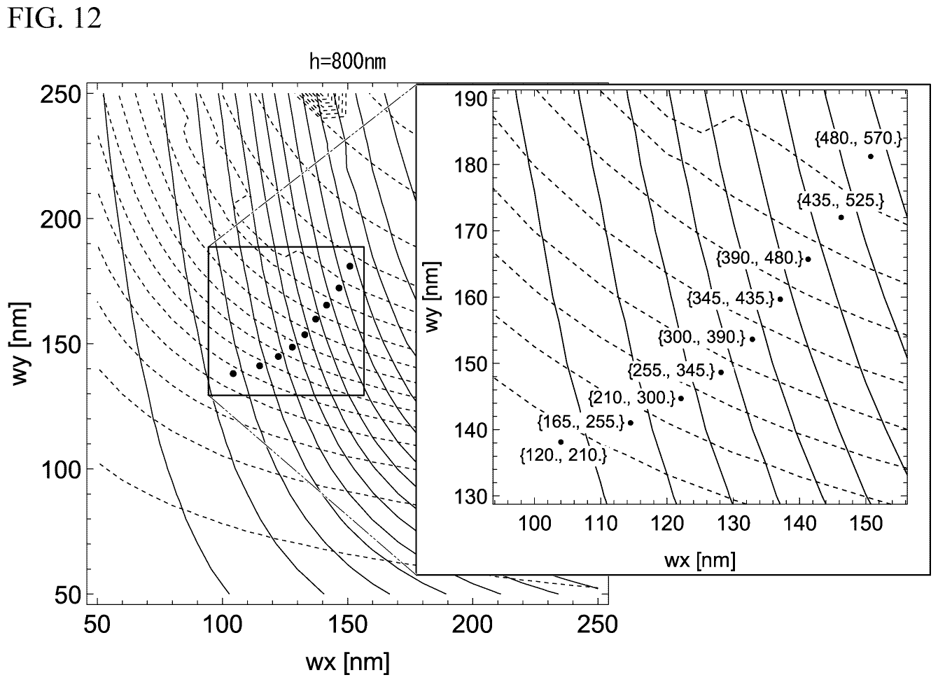

FIG. 12 illustrates a result of electromagnetic field analysis of the optical element 3 constituted by a ¼ wavelength plate. In electromagnetic field analysis, the heights of the pillar-shaped bodies 3T formed of single-crystal Si are fixed to 800 nm, and calculation is performed while changing the widths wx and wy in the x and y directions. In the drawing, solid lines indicate contour lines of ϕx, dotted lines indicate contour lines of ϕy, and black points indicate (ϕx, ϕ) satisfying a design solution.

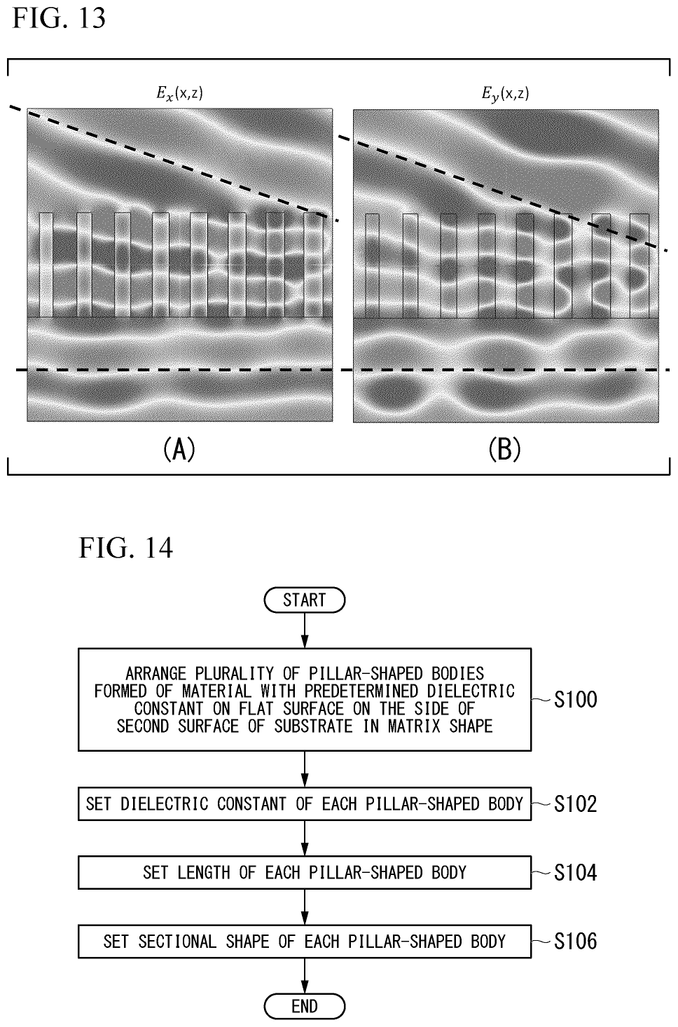

FIG. 13 illustrates an example of electromagnetic field analysis using a design solution indicated by black points in FIG. 12. FIG. 13(A) illustrating an electric field distribution of x polarized light, and FIG. 13(B) illustrates an electric field distribution of y polarized light. As illustrated in the drawing, it can be seen that the phases on an input side are almost the same and the phase ϕy on the output side is later by 90° than the phase ϕx.

The optical element 3 designed as described above serves as a ¼ wavelength plate adjusted to have ¼ wavelength, that is, a phase difference of π/4, between a vertically polarized component and a horizontally polarized component in the propagation direction of light. With the optical element 3 constituted by a ¼ wavelength plate, in a case where the optical element 3 is disposed as the first optical element layer 4 at the first position P1, linearly polarized light output from the light source L can be output as circularly polarized light (see FIG. 1). With the optical element 3 constituted by a ¼ wavelength plate, in a case where the optical element 3 is disposed as the second optical element layer 5 at the second position P2, circularly polarized light reflected by the second reflecting plate 13 can be received, and output light can be converted to linearly polarized light and input to the detector D (see FIG. 1).

With the optical element 3 constituted by a ¼ wavelength plate, a difference in optical characteristics of a sample M from circularly polarized light can be used through conversion to circularly polarized light. The phase difference in the third function may be arbitrarily set. For example, the optical element 3 may be formed as a ¼ wavelength plate of left turn or a ¼ wavelength plate of right turn by adjusting the phase difference in the third function. The optical element 3 may be formed as a ½ wavelength plate by adjusting the phase difference in the third function. As described above, the third function may be superimposed on the first function and the second function to design the optical element 3. The optical element 3 as described above is adjusted such that a phase difference is caused between the first phase in the first direction of output light and the second phase in the second direction and the output light has a desired polarized wave characteristics in the normal direction.

FIG. 14 illustrates a process flow of steps that are performed in the method of designing the optical element 3. The optical element 3 is designed, for example, using an information processing terminal device such as a personal computer. A plurality of pillar-shaped bodies 3T formed of a material with a predetermined dielectric constant on the flat surface on the side of a second surface 2B of the transparent substrate 2 transmitting light which is input from the side of a first surface 2A are arranged in a matrix shape (Step S100). The dielectric constants of the pillar-shaped bodies 3T are set (Step S102). The length in the normal direction with respect to the flat surface of each pillar-shaped body 3T is set (Step S104). A sectional shape in a direction parallel to the flat surface of each pillar-shaped body 3T is set (Step S106).

In Step S106, the sectional shape is adjusted such that phase adjustment is performed on output light which is output by transmission of input light passing through the substrate on the basis of the phase distribution for realizing desired polarized light characteristics and output output light having a desired polarized light characteristics is output on the basis of deflection characteristics with respect to the normal direction, lens characteristics of condensing light in the normal direction, and polarized wave characteristics in the normal direction.

The optical cell 1 may be applied to, for example, device spectroscopic instrument that performs spectroscopic analysis. The optical cell 1 may be applied to a microfluidic device to integrate spectroscopic analysis functions. Technology of micro-total analysis systems (TAS) in which microfluidic channels are complexly integrated using micro electro-mechanical systems (MEMS) is known as a system for efficiently mixing and reacting a minute number of samples. The micro TAS is an analysis device in which a minute open type flow channel, reaction chamber, or mixing chamber is provided on a chip and which analyzes various liquids or gases using one device. With the optical cell 1, it is possible to construct a low-price spectroscopic analysis device with enhanced versatile applications by assembling the micro TAS along with a light source L and a detector D into one chip. In a case where the optical cell is applied to a microfluidic device, it is possible to construct an analysis device by employing a metasurface structure in consideration of a refractive index of a medium flowing in a flow channel.

The optical cell 1 may be applied to, for example, a gas cell for an atomic clock to miniaturize a device configuration. The optical cell 1 may be applied to a closed system such as a gas cell of an atomic clock in addition to the closed type device. In the optical cell 1, in a case where the flow channel 11 is configured as a closed gas cell, it is possible to enhance an interference length with a gas and to single-sided mount a light source L such as a laser chip and a detector D such as a photodetector on the substrate 2. In a case where the optical cell 1 is applied to a gas cell for an atomic clock, elements of the light source L and the detector D can be formed as a single chip. In a case where the optical cell 1 is applied to a gas cell for an atomic clock, light is input to an optical cell in which cesium vapor is housed, an oscillator of an atomic clock is formed using optical characteristics such as a frequency of output excited light, and a quantum interference unit of the atomic clock can be greatly decreased in size and profile.

As described above, since the optical element 3 has the metasurface structure in which a plurality of pillar-shaped bodies 3T are arranged in a matrix shape, it is possible to realize an element having optical characteristics indicating a desired deflection direction, a desired light condensing, and a desired polarized state. With the optical element 3, the deflection characteristics, the lens characteristics, and the polarized wave characteristics can be adjusted by adjusting the sectional area of each pillar-shaped body 3T, and it is possible to output output light having a desired polarized light characteristics. With the optical element 3, it is possible to adjust a phase distribution on the basis of the first function and to adjust deflection characteristics such as a deflection angle. With the optical element 3, it is possible to deflect light in only one direction and to enhance transmission efficiency of light in comparison with a diffraction grating for diffracting light in two directions. Particularly, in a case where the optical element 3 is applied to a gas cell for an atomic clock, it is possible to greatly improve transmission efficiency of light using the optical element 3 in comparison with a gas cell for an atomic clock described in Patent Document 1 including a diffraction grating for diffracting light in two directions.

With the optical element 3, it is possible to adjust lens characteristics of light condensing on the basis of the second function. With the optical element 3, it is possible to adjust polarized wave characteristics of a phase plate or the like on the basis of the third function. With the optical element 3, it is possible to realize an optical element having a desired deflection direction, a desired light condensing, and a desired polarized state using a single layer by adjusting the shapes and arrangement of the pillar-shaped bodies 3T on the basis of a phase distribution function in which functions indicating phase distributions such as the first function, the second function, and the third function are arbitrarily combined. The first function, the second function, and the third function are merely examples, and phase distribution functions having desired polarized light characteristics may be used.

Modified examples of the optical element 3 and the optical cell 1 will be described below. In the following description, the same elements as in the aforementioned embodiment will be referred to by the same names and reference signs, and repeated descriptions will be appropriately omitted.

### Modified Example 1

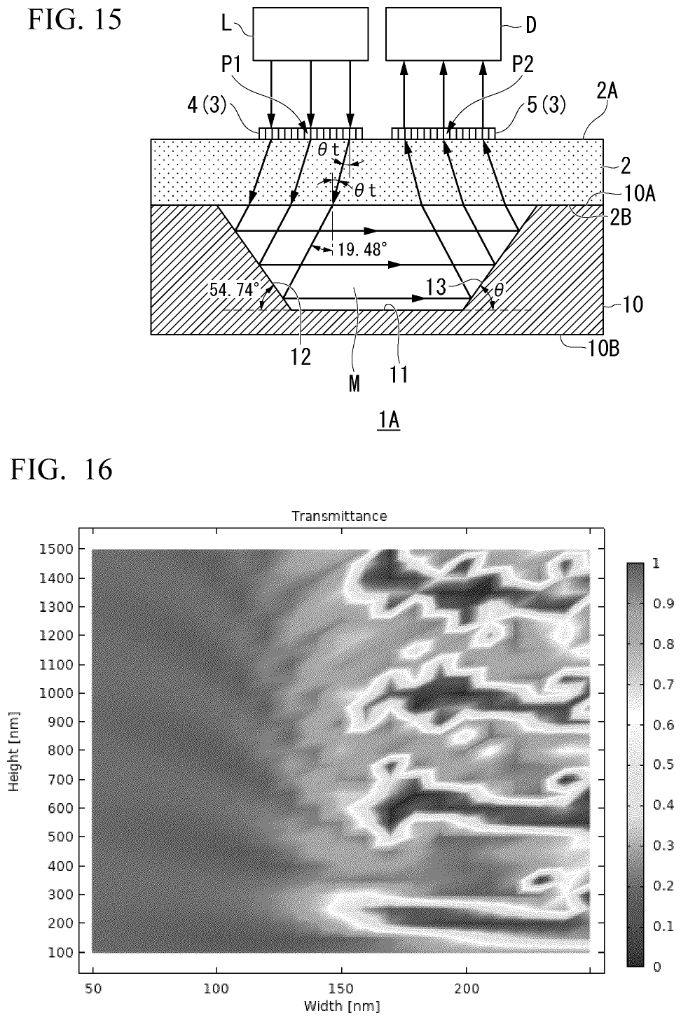

As illustrated in FIG. 15, a first optical element layer 4 and a second optical element layer 5 of an optical cell 1A may be provided on a first surface 2A side of the substrate 2. At an interface between the optical element 3 and the first surface 2A of the substrate 2 (glass), the polarization angle θt of the optical element 3 needs to satisfy conditions of Expression (7), where a refractive index of glass is defined as nt.

$$\begin{matrix}[ Math . 7 ] & \\ {n}_{t} sin {θ}_{t} = \frac{λ}{2 π} \frac{d ϕ}{d x} & ( 7 )\end{matrix}$$

At an interface between a second surface 2B of the substrate 2 and the flow channel 11, the polarization angle θt of the optical element 3 needs to satisfy conditions of Expression (8).

$$\begin{matrix}[ Math . 8 ] & \\ 1 \cdot sin 19.48 ° = {n}_{t} sin {θ}_{t} & ( 8 )\end{matrix}$$

Accordingly, the phase gradient required for the optical element 3 is expressed by Expression (9).

$$\begin{matrix}[ Math . 9 ] & \\ \frac{d ϕ}{d x} = \frac{2 π}{λ / sin 19.48 °} & ( 9 )\end{matrix}$$

Expression (9) is the same as Expression (3) and does not depend on the refractive index nt. Accordingly, the optical cell 1A can be constructed to achieve the same advantages as the optical cell 1 even in a case where the optical element 3 used for the optical cell 1 is disposed on the first surface 2A side of the substrate 2. In the optical element 3, the first optical element layer 4 and the second optical element layer 5 may be provided on any side of the first surface 2A side and the second surface 2B side of the substrate 2. As described above, with the optical cell 1A, it is possible to provide the optical element 3 on the first surface 2A side of the substrate 2 and to enhance a degree of freedom in design.

### Modified Example 2

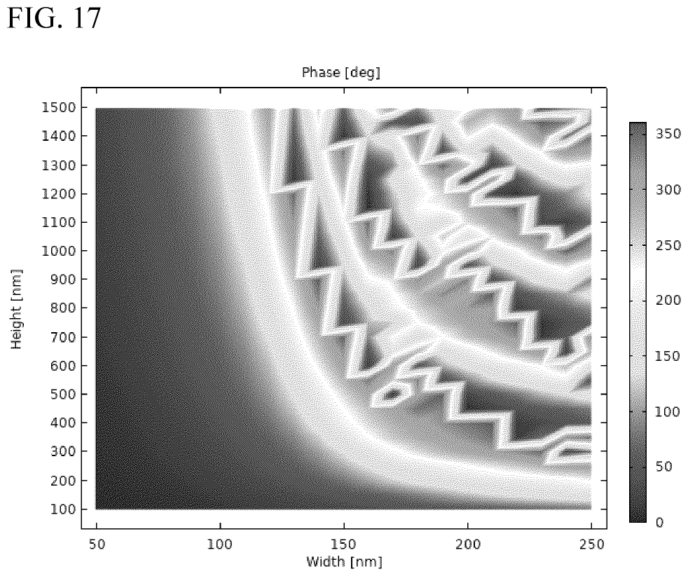

In the aforementioned embodiment, the pillar-shaped bodies 3T of the optical element 3 are designed with a fixed length. The pillar-shaped bodies 3T may be designed with the length as a parameter. As illustrated in FIG. 16, transmittance changes periodically by adjusting the length of the pillar-shaped bodies 3T in a range greater than a predetermined width. As illustrated in FIG. 17, an amount of phase delay changes periodically by adjusting the length of the pillar-shaped bodies 3T in a range greater than a predetermined width. Transmittance of the optical element 3 may be adjusted by arranging pillar-shaped bodies 3T with different lengths. The optical element 3 may generate interference light by arranging pillar-shaped bodies 3T with different lengths.

While an embodiment of the present invention has been described above, the present invention is not limited to the embodiment and can be subjected to various modifications and substitutions without departing from the gist of the present invention. For example, in the optical element 3, the sectional shape of each pillar-shaped body 3T may be elliptical well as rectangular. In the etching process for forming the pillar-shaped bodies 3T, corners of a rectangular section are not formed but a shape close to an ellipse is formed. In a case where the phase distribution of a plurality of pillar-shaped bodies 3T are calculated, the sectional shape may be deformed to an elliptical shape in advance and may be corrected to have desired polarized light characteristics. In order to adjust polarized light characteristics of the formed optical element 3, an adjustment optical element 3 may be separately stacked.

### REFERENCE SIGNS LIST

1, 1A Optical cell
2 Substrate
3 Optical element
3T Pillar-shaped body
4 First optical element layer
5 Second optical element layer
10 Housing layer
11 Flow channel
100 Analysis device
D Detector
L Light source
P1 First position
P2 Second position

1. An optical element comprising a plurality of pillar-shaped bodies that are formed of a material with a predetermined dielectric constant on a flat surface of a transparent substrate through which light is transmitted and that are arranged in a matrix shape,
wherein each pillar-shaped body is formed to perform phase adjustment on output light which is output by transmission of input light, on the basis of the dielectric constant, a sectional shape in a direction parallel to the flat surface, and a length in a normal direction with respect to the flat surface, to adjust deflection characteristics with respect to the normal direction, lens characteristics with respect to the normal direction, and polarized wave characteristics with respect to the normal direction, and to output the output light having desired polarized light characteristics.

2. The optical element according to claim 1, wherein a first width in a first direction along the flat surface and a second width in a second direction perpendicular to the first direction along the flat surface in the sectional shape of each of the plurality of pillar-shaped bodies are adjusted on the basis of a first function indicating a phase distribution of the output light on the flat surface, the plurality of pillar-shaped bodies are sequentially arranged in the first direction and the second direction such that a sectional shape providing a phase closest to a remainder of the first function with respect to 27c is satisfied, and the phase and the polarized light characteristics are adjusted such that the output light has a desired deflection angle with respect to the normal direction.

3. The optical element according to claim 2, wherein the first width and the second width in the sectional area of each of the plurality of pillar-shaped bodies are adjusted on the basis of a second function indicating a phase distribution of the output light on the flat surface, and the phase and the lens characteristics are adjusted such that the output light has a focal point at a desired focal distance with respect to the normal direction.

4. The optical element according to claim 3, wherein the first width and the second width in the sectional area of each of the plurality of pillar-shaped bodies are adjusted on the basis of a third function indicating a phase distribution of the output light on the flat surface, a phase difference is generated between a first phase in the first direction and a second phase in the second direction of the output light, and adjustment is performed such that the output light has a desired polarized wave characteristics in the normal direction.

5. An optical cell comprising:
a substrate that is formed of a material transmitting light;
a first optical element layer that is formed of the optical element according to claim 1 and disposed at a first position on the substrate;
a housing layer in which a housing space for housing a material to be examined is formed and a plurality of reflecting plates are formed to reflect the output light output from the first optical element layer into the housing space and to output the output light to a second position on the substrate; and
a second optical element layer that is formed of the optical element according to claim 1 and disposed at the second position.

6. An analysis device comprising:
the optical cell according to claim 5;
a light source provided to input light to the first position on the substrate; and
a detector configured to detect the output light output from the second position.

7. An optical element design method comprising:
a step of arranging a plurality of pillar-shaped bodies in a matrix shape on a flat surface on the side of a second surface of a transparent substrate transmitting light input from the side of a first surface out, the plurality of pillar-shaped bodies being formed of a material with a predetermined dielectric constant;
a step of setting the dielectric constant of each of the plurality of pillar-shaped bodies;
a step of setting a length of each pillar-shaped body in a normal direction with respect to the flat surface; and
a step of setting a sectional shape of each pillar-shaped body in a direction parallel to the flat surface,
wherein the sectional shape adjusts a phase of output light which is output by transmission of input light, and performs adjustment to output the output light having a desired polarized light characteristics on the basis of deflection characteristics with respect to the normal direction, lens characteristics with respect to the normal direction, and polarized wave characteristics with respect to the normal direction.
